(19) United States
(12) Patent Application Publication
(10) Pub. No.: US 2025/0142473 A1
(43) Pub. Date: May 1, 2025

(54) WAKE-UP SIGNALS

(71) Applicant: Nokia Technologies Oy, Espoo (FI)

(72) Inventors: Knud KNUDSEN, Aalborg (DK); David BHATOOLAUL, Swindon (GB); Jan Torst HVIID, Aalborg (DK); Alok SETHI, Oulu (FI); SunYoung LEE, Seoul (KR)

(21) Appl. No.: 18/930,185

(22) Filed: Oct. 29, 2024

(30) Foreign Application Priority Data
Oct. 31, 2023 (GB) 2316640.8

(51) Int. Cl. H04W 52/02

(52) U.S. Cl. CPC H04W 52/0229

(57) ABSTRACT

Examples of the disclosure relate to wake-up signals for devices with no main radio or for which a main radio is turned off. An apparatus can be arranged in a low power state and can be arranged to receive a wake-up signal via a low power receiver when in the low power state. The wake-up signal comprises information identifying an apparatus or type of apparatus, and instructions to perform one or more actions in response to the wake-up signal. The apparatus can determine if the wake-up signal is intended for the apparatus based on the information identifying an apparatus or type of apparatus in the wake-up signal. The apparatus can perform the one or more actions indicated in the wake-up signal based on the determination.

### CROSS-REFERENCE TO RELATED APPLICATION

This application claims priority from, and the benefit of, GB Application No. GB2316640.8, filed on 31 Oct. 2023, the contents of which are hereby incorporated by reference in its entirety.

### TECHNOLOGICAL FIELD

Examples of the disclosure relate to wake-up signals. Some relate to wake-up signals for devices with no main radio or for which a main radio is turned off.

### BACKGROUND

There may be circumstances in which it is useful to enable one or more network devices to communicate with a device that is not equipped with a main radio or for which the main radio is turned off. For example, a low cost tracking device could be added to life vests or other clothing. The low cost tracking device could comprise a low power receiver and could be used to facilitate the provision of aid in the event of an accident or emergency.

### BRIEF SUMMARY

According to various, but not necessarily all, examples of the disclosure there may be provided an apparatus comprising:
means for arranging the apparatus in a low power state;
means for receiving a wake-up signal wherein the means for receiving comprises a low power receiver that is operable in the low power state and the wake-up signal comprises information identifying an apparatus or type of apparatus, and instructions to perform one or more actions in response to the wake-up signal;
means for determining if the wake-up signal is intended for the apparatus based on the information identifying an apparatus or type of apparatus in the wake-up signal; and
means for performing the one or more actions indicated in the wake-up signal based on the determination.

The apparatus may comprise means for transitioning the apparatus to a high power state to perform the one or more actions.

The apparatus may comprise a main radio wherein the main radio is separate from the low power receiver, has a higher power usage than the low power receiver and is arranged in an off state when the apparatus is in the low power state.

The wake-up signal may be modulated so that the wake-up signal can be received by an on-off keying receiver.

The one or more actions may comprise transmitting a wake-up confirm signal.

The wake-up confirm signal may comprise at least one of:
location information of the apparatus;
an indication of one or more actions that have been initiated by the apparatus.

The wake-up confirm signal may be modulated using on-off keying.

The apparatus may comprise means for receiving a signal in response to the one or more actions wherein the signal indicates that one or more of the actions performed by the apparatus have been observed.

The apparatus may be at least one of, an emergency device, a sensing device, a localisation device, an Internet of Things device.

According to various, but not necessarily all, examples of the disclosure there may be provided a method comprising:
arranging an apparatus in a low power state;
receiving a wake-up signal wherein the wake-up signal is received using a low power receiver that is operable in the low power state and the wake-up signal comprises information identifying an apparatus or type of apparatus, and instructions to perform one or more actions in response to the wake-up signal;
determining if the wake-up signal is intended for the apparatus based on the information identifying an apparatus or type of apparatus in the wake-up signal; and
performing the one or more actions indicated in the wake-up signal based on the determination.

According to various, but not necessarily all, examples of the disclosure there may be provided a computer program comprising instructions which, when executed by an apparatus, cause the apparatus to perform at least the following:
arranging the apparatus in a low power state;
receiving a wake-up signal wherein the wake-up signal is received using a low power receiver that is operable in the low power state and the wake-up signal comprises information identifying an apparatus or type of apparatus, and instructions to perform one or more actions in response to the wake-up signal;
determining if the wake-up signal is intended for the apparatus based on the information identifying an apparatus or type of apparatus in the wake-up signal; and
performing the one or more actions indicated in the wake-up signal based on the determination.

According to various, but not necessarily all, examples of the disclosure there may be provided a user equipment comprising:
means for determining whether the user equipment satisfies one or more location criteria; and
means for broadcasting a wake-up signal based on the determination wherein the wake-up signal comprises information identifying an apparatus or type of apparatus, and instructions to perform one or more actions in response to the wake-up signal.

The wake-up signal may be modulated so that the wake-up signal can be received by an on-off keying receiver.

The user equipment may comprise means for receiving a broadcast signal wherein the broadcast signal indicates the one or more location criteria.

The user equipment may comprise means for receiving a request to broadcast the wake-up signal.

The information identifying an apparatus or type of apparatus, and instructions to perform one or more actions used in the wake-up signal may be based on information received in the request to broadcast the wake-up signal.

The user equipment may comprise means for transmitting an indication that one or more actions performed by an apparatus have been observed.

The user equipment may comprise means for detecting a user input and broadcasting the wake-up signal in response to the detected user input.

According to various, but not necessarily all, examples of the disclosure there may be provided a method comprising:
determining whether a user equipment satisfies one or more location criteria; and
broadcasting a wake-up signal based on the determination wherein the wake-up signal comprises information identifying an apparatus or type of apparatus, and instructions to perform one or more actions in response to the wake-up signal.

According to various, but not necessarily all, examples of the disclosure there may be provided a computer program comprising instructions which, when executed by a user equipment, cause the user equipment to perform at least the following:
determining whether the user equipment satisfies one or more location criteria; and
broadcasting a wake-up signal based on the determination wherein the wake-up signal comprises information identifying an apparatus or type of apparatus, and instructions to perform one or more actions in response to the wake-up signal.

According to various, but not necessarily all, examples of the disclosure there may be provided a network node comprising:
means for broadcasting a signal indicating one or more location criteria;
means for using received responses to the broadcast signal to select to one or more user equipments for broadcasting a wake-up signal; and
means for transmitting a request to broadcast the wake-up signal wherein the request is transmitted to the one or more selected user equipment.

The one or more user equipments may be selected based on location criteria.

The request to broadcast a wake-up signal may comprise information to be used in the wake-up signal.

The network node may be one of:
a base station,
a satellite.

According to various, but not necessarily all, examples of the disclosure there may be provided a method comprising:
broadcasting a signal indicating one or more location criteria;
using received responses to the broadcast signal to select to one or more user equipments for broadcasting a wake-up signal; and
transmitting a request to broadcast the wake-up signal wherein the request is transmitted to the one or more selected user equipment.

According to various, but not necessarily all, examples of the disclosure there may be provided a computer program comprising instructions which, when executed by a network node, cause the network node to perform at least the following:
broadcasting a signal indicating one or more location criteria;
using received responses to the broadcast signal to select to one or more user equipments for broadcasting a wake-up signal; and
transmitting a request to broadcast the wake-up signal wherein the request is transmitted to the one or more selected user equipment.

According to various, but not necessarily all, examples of the disclosure there may be provided a network node comprising:
means for broadcasting a wake-up signal wherein the wake-up signal comprises information identifying an apparatus or type of apparatus and instructions to perform one or more actions in response to the wake-up signal.

The wake-up signal may be modulated so that the wake-up signal can be received by an on-off keying receiver.

The wake-up signal may be broadcast using fixed radio resources.

The wake-up signal may be repeated over a full discontinuous reception period.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

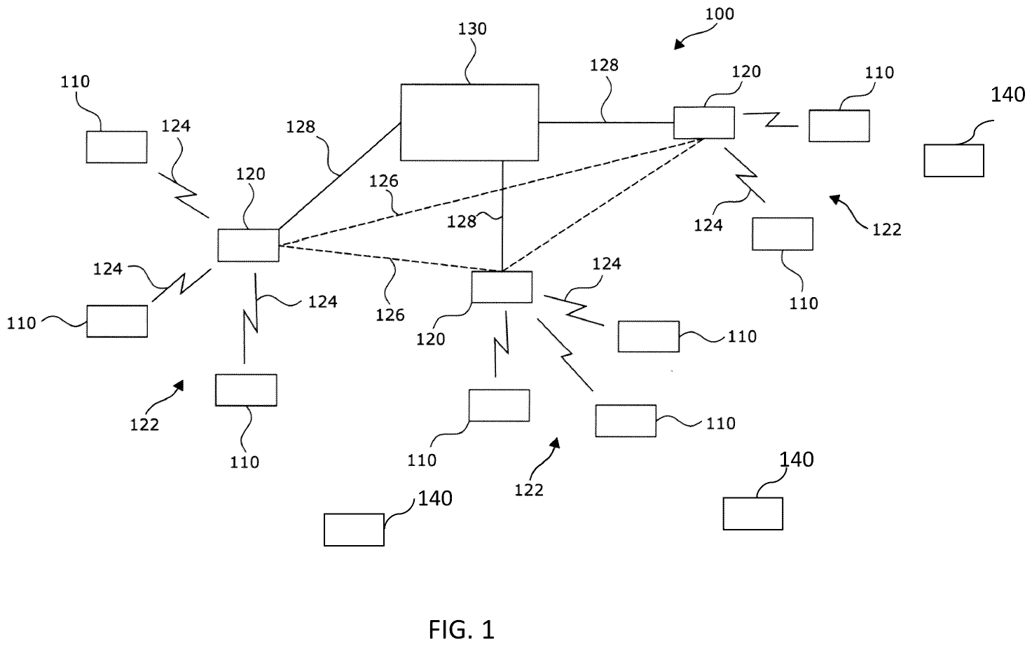

FIG. 1 shows an example network;

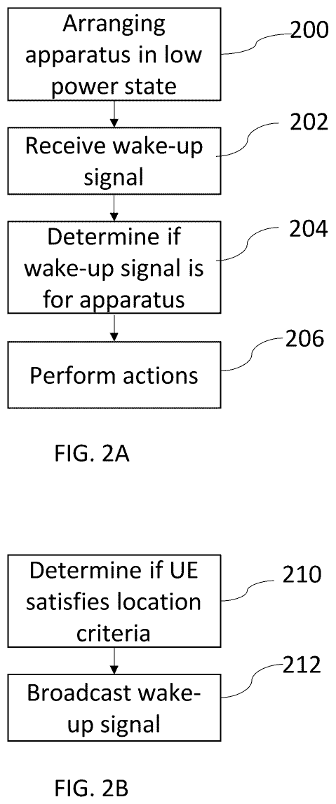

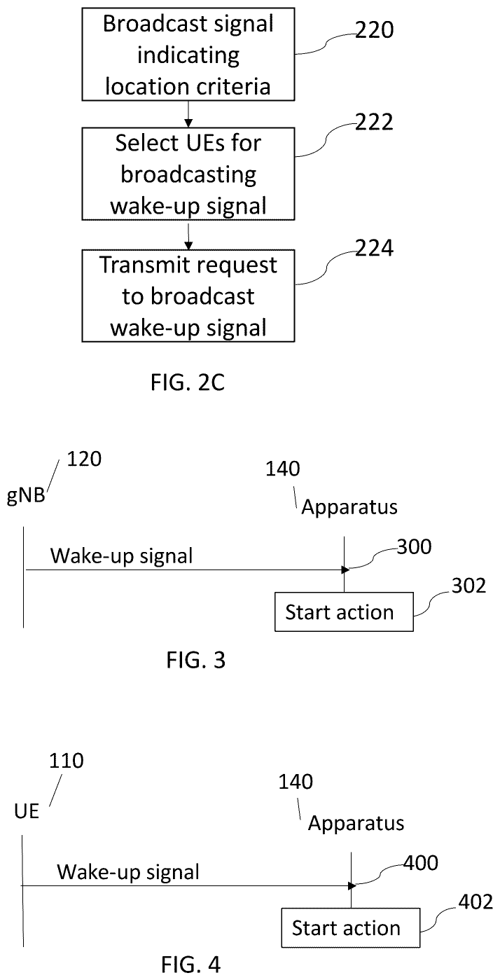

FIGS. 2A to 2C show example methods;

FIG. 3 shows an example method;

FIG. 4 shows an example method;

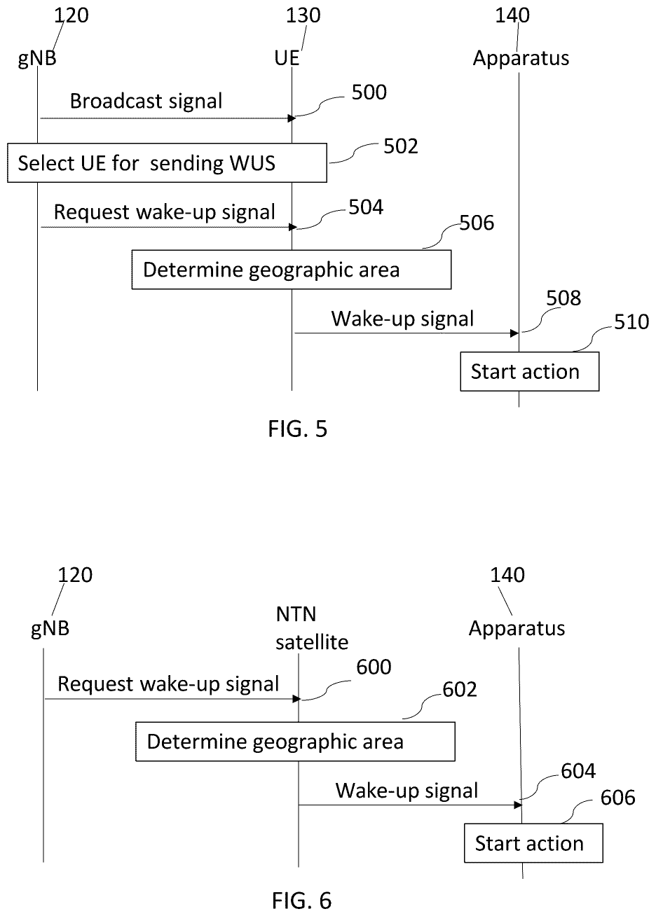

FIG. 5 shows an example method;

FIG. 6 shows an example method;

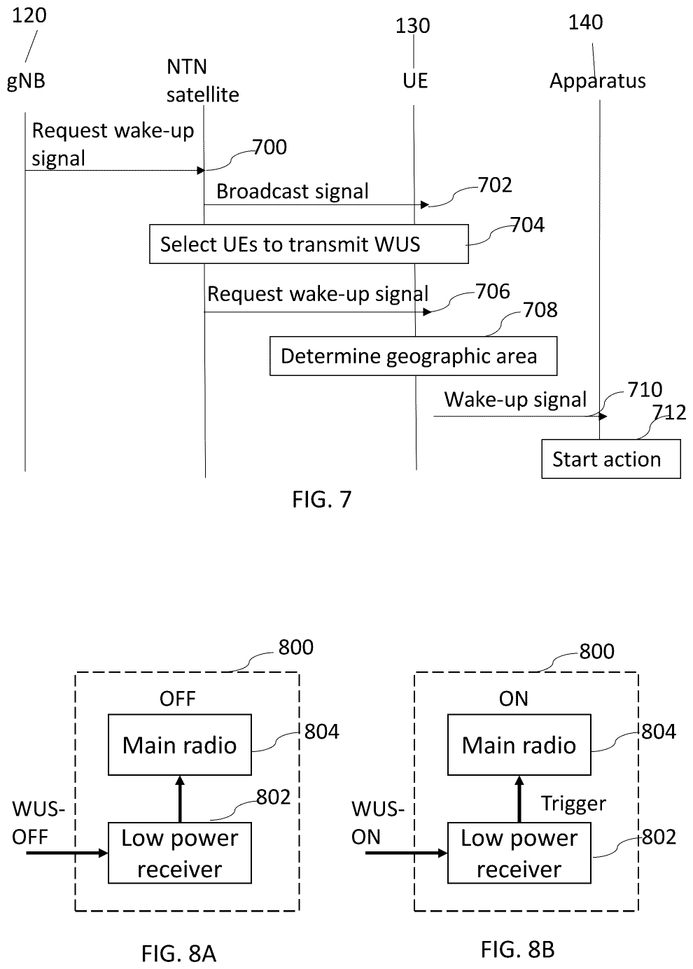

FIG. 7 shows an example method;

FIGS. 8A and 8B show an example device with a low power receiver;

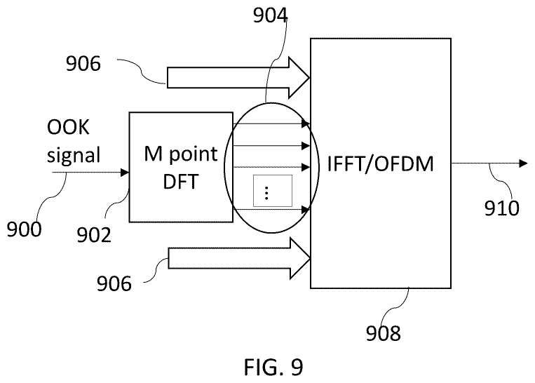

FIG. 9 shows multi-carrier on-off keying signal generation;

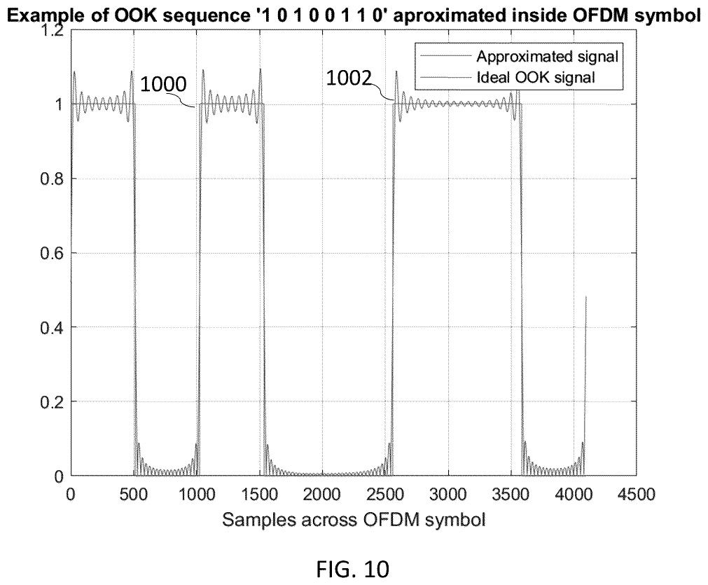

FIG. 10 shows an on-off keying signal inside an Orthogonal Frequency Division Multiplexing symbol;

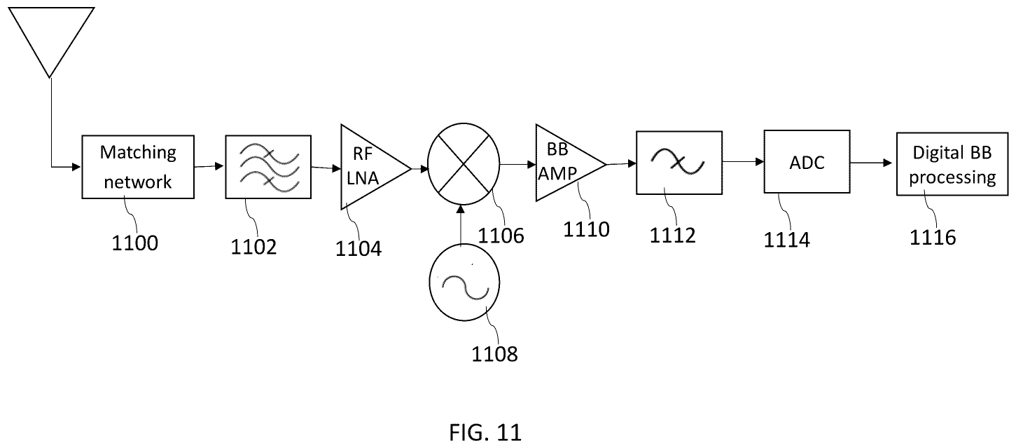

FIG. 11 shows an on-off keying receiver;

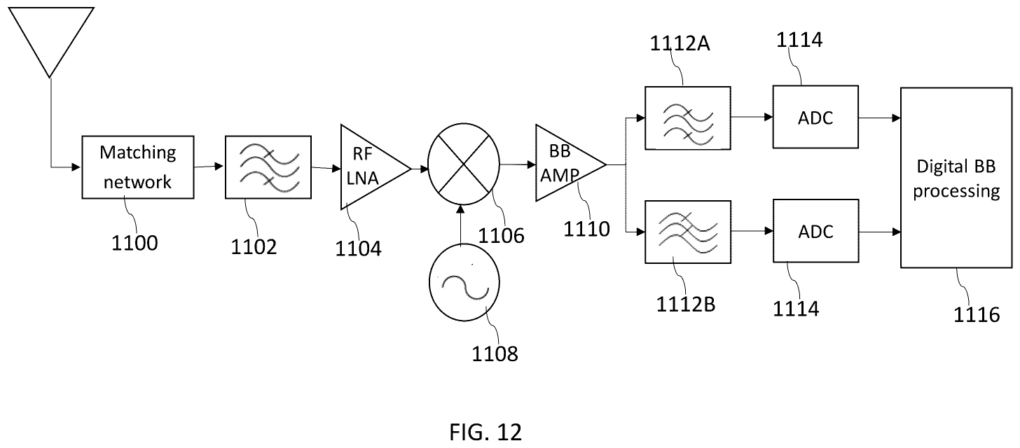

FIG. 12 shows an on-off keying receiver; and

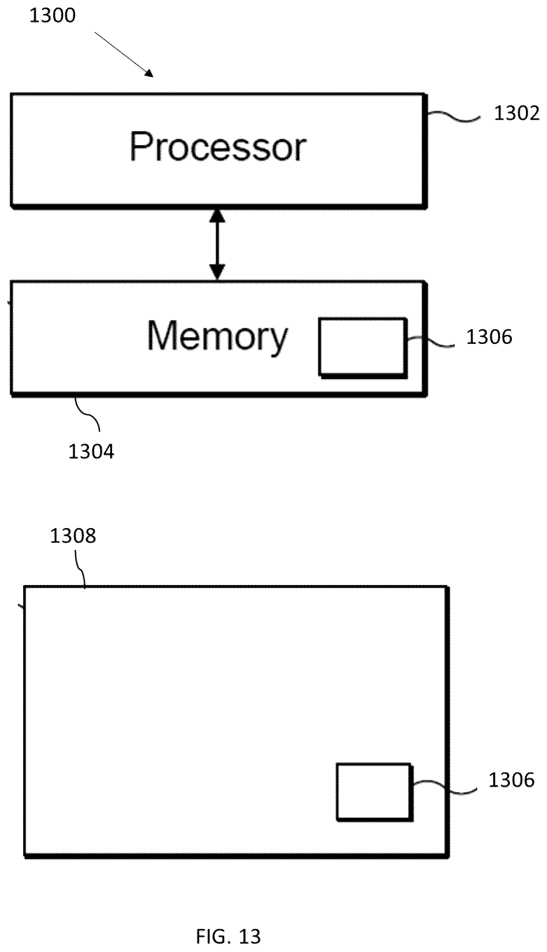

FIG. 13 shows an example controller.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### Definitions

3GPP A standardization body
ADC Analog Digital Converter
BPF Band Pass Filter
BW Bandwidth
DFT Direct Fourier Transform
FSK Frequency Shift Keying
gNB 5G base station
IF Intermediate Frequency
IFFT Inverse Fast Fourier Transform
ISI Inter Symbol Interference
LNA Low Noise Amplifier
LPF Low Pass Filter
LR Low-Power Radio
MC-OOK Multi-Carrier OOK
MR Main Radio
NR New Radio
NTN Non-Terrestrial Networks
OFDM Orthogonal Frequency Division Multiplexing
OOK On-off keying
RE Resource Element
RF Radio Frequency
RRC Radio Resource Control
SCS Sub Carrier Spacing
SIB System Information Broadcast
UE user equipment
WUR Wake-up receiver
WUS Wake-up signal

### DETAILED DESCRIPTION

FIG. 1 illustrates an example of a network 100 such as a 5G NR network. The network 100 comprises a plurality of user equipments (UE) 110 and a plurality of network entities 120, 130. The network entities 120, 130 can comprise one or more network nodes 120 that can be configured to communicate with the UEs 110. The network entities can also comprise one or more core network apparatus 130. The one or more core network apparatus 130 communicate with the network nodes 120. In some examples the one or more core network apparatus 130 communicate with the UEs 110. The network 100 can also comprise one or more apparatus 140. The apparatus 140 might not comprise a main radio or might comprise a main radio in an off state. The apparatus 140 can comprise a low power receiver that can be configured to receive wake-up signals.

The one or more core network apparatus 130 can, in some examples, communicate with each other. The one or more network nodes 120 can, in some examples, communicate with each other.

The network 100 can be a cellular network comprising a plurality of cells 122 each served by a network node 120. In this example, the interface between the UE 110 and a network node 120 defining a cell 122 is a wireless interface 124.

The network node 120 comprises one or more cellular radio transceivers. The UE 110 comprises one or more cellular radio transceivers. The cellular radio transceiver can comprise a main radio for the UE 110. The apparatus 140 could comprise one or more cellular radio transceivers but these can be powered in an off state so that the apparatus 140 does not receive signals via a wireless interface 124.

In the example illustrated the cellular network 100 is a third generation Partnership Project (3GPP) network. The network nodes 120 can be access nodes such as base stations (gNB) or other type of access node. The network node 120 can be a network entity responsible for radio transmission and reception in one or more cells to or from the UE 110. In some examples the network nodes 120 could comprise satellites such as Non-Terrestrial Networks (NTN) satellites.

The term UE is used to designate mobile equipment comprising a smart card for authentication/encryption etc. such as a Subscriber Identity Module (SIM). In some examples the term ‘user equipment’ is used to designate mobile equipment comprising circuitry embedded as part of the user equipment for authentication/encryption such as software SIM.

The core network apparatus 130 can be part of a core network. The core network apparatus 130 can be configured to manage functions relating to connectivity for the UEs 110. For example, the core network apparatus 130 can be configured to manage functions such as connectivity, mobility, authentication, authorization and/or other suitable functions.

In the example of FIG. 1 the core network apparatus 130 is shown as a single entity. In some examples the core network apparatus 130 could be distributed across a plurality of entities. For example, the core network apparatus 130 could be cloud based or distributed in any other suitable manner.

The network 100 can be a 4G or 5G network, for example. It can for example be a New Radio (NR) network that uses gNB or eNB as network nodes 120. New Radio is the 3GPP name for 5G technology. In such cases the network nodes 120 can comprise gNodeBs (gNBs) 120 configured to provide user plane and control plane protocol terminations towards the UE 110 and/or to perform any other suitable functions. The network nodes 120 are interconnected with each other by means of an X2/Xn interface 126. The network nodes 120 are also connected by means of the N2 interface 128 to the core network apparatus 130. Other types of networks and interfaces could be used in other examples. Other types of networks could comprise next generation mobile and communication network, for example, a 6G network.

In some use case scenarios it might be useful to instruct one or more apparatus 140 to perform one or more actions. For instance, if the apparatus 140 are part of emergency devices they could be instructed to perform actions that could help the apparatus 140 be located or otherwise facilitate the provision of aid or warnings. The actions that can be performed in such scenarios could be the transmission of a signal or providing other types of output that can be detected by nearby devices. In some examples the apparatus 140 could be sensing devices. In such examples it could be useful to instruct the sensing devices to make one or more measurements and/or report the measurements.

The apparatus 140 might be a low power device that does not have a main radio or has a main radio that is turned off. Also the apparatus 140 could be out of network coverage. This means that the apparatus 140 cannot be controlled using ordinary cellular signals. Therefore examples of the disclosure enable such apparatus 140 to be contacted and instructed to perform one or more actions through the use of a low power wake-up signal that can be detected without a main radio.

FIGS. 2A to 2C show example methods that could be used in examples of the disclosure.

FIG. 2A shows an example method that could be implemented by an apparatus 140. The apparatus 140 could be a device with a low power receiver and no main radio. In some examples the apparatus 140 could comprise a main radio that is turned off or arranged in a sleep mode. FIGS. 8A and 8B show an example device that could be used as an apparatus 140.

In some examples the apparatus 140 could be part of a more complex device or integrated within another product. In some examples the apparatus 140 could be integrated within a wearable product such as a life jacket or wrist band or other tag that could be worn by a user or attached to any suitable entity.

In some examples the apparatus 140 could be an emergency device. The emergency device can be used to help to find, or provide other aid or warnings for, a user or entity associated with the emergency device. The emergency device could be an item of clothing or part of an item of clothing or tag that is attached to a user or other items associated with a user.

In some examples the apparatus 140 could be a sensing device. The sensing device could be remotely located so that it might not be able to access a network 100 or could be very low power device that does not have a main radio. The sensing device could comprise one or more sensors that could measure environmental parameters and could be used to monitor weather conditions or other environmental conditions.

In some examples the apparatus 140 could comprise a localisation device. The localisation device could be used to determine the location of a user of the device. This could be used to help to locate things that are lost such as people or belongings.

In some examples the apparatus 140 could comprise Internet of Things device or any other suitable type of device.

In the example of FIG. 2A the method comprises, at block 200, arranging the apparatus 140 in a low power state. The low power state can be a state in which a low power receiver is arranged to receive a wake-up signal WUS but in which other components of the apparatus 140 are turned off or arranged in a sleep mode so that they reduce power consumption. For instance, if the apparatus 140 comprises a main radio, then the main radio could be arranged in an off state in the low power state. The main radio and the low power receiver can be separate to each other in that they can be operated independently of each other. The off state can be state in which no signals are received or transmitted by the main radio. The off state could be a state in which the main radio is completely turned off or a sleep mode.

If the apparatus 140 comprises components for performing one or more actions then these could be turned off or arranged in a sleep mode when the apparatus 140 is arranged in the low power state. The components for performing one or more actions could be output means such as loudspeakers or light sources. In some examples the components for performing one or more actions could comprise sensors or any other suitable means.

At block 202 the method comprises receiving a wake-up signal. The wake-up signal can be received using a low power receiver that is operable in the low power state.

The wake-up signal comprises information identifying an apparatus or type of apparatus, and instructions to perform one or more actions in response to the wake-up signal.

The wake-up signal can be modulated so that the wake-up signal can be received by a low power receiver. In some examples the wake-up signal can be modulated so that it can be received by an on-off keying (OOK) receiver. The wake-up signal does not need to use OOK. For instance, Orthogonal Frequency Division Multiplexing (OFDM) or other types of modulation can be used to mimic OOK.

At block 204 the method comprises determining if the wake-up signal is intended for the apparatus 104 based on the information identifying an apparatus 140 or type of apparatus 140 in the wake-up signal.

At block 206 the method comprises performing the one or more actions indicated in the wake-up signal based on the determination. If it is determined that the wake-up signal is intended for the apparatus 140 then the one or more actions can be performed. If is determined that the wake-up signal is not intended for the apparatus 140 then the one or more actions are not performed.

The apparatus 140 can be transitioned from the low power state to the high power state to enable the apparatus 140 to perform the one or more actions. As an example, an action that is performed at block 206 could be transmitting a wake-up confirm signal. In order to enable the wake-up confirm signal to be transmitted the apparatus 140 can be transitioned out of the low power state by turning on a main radio of the apparatus 140 so as to enable the wake-up confirm signal to be transmitted.

The wake-up confirm signal can be used to indicate that the apparatus 140 has received the wake-up signal. In some examples the wake-up confirm signal can comprise an indication of the location of the apparatus 140 and/or an indication that the apparatus 140 has started the one or more actions as instructed in the wake-up signal. The wake-up confirm signal can be modulated using OOK or any other suitable type of modulation and can be transmitted by the main radio.

In some examples other components of the apparatus 140 could be transitioned from an off or sleep state to an active state in which the actions can be performed. For instance output devices or sensors could be arranged into an active mode to enable appropriate functions to be performed.

In some examples the method can comprise blocks that are not shown in FIG. 2A. For instance, the apparatus 140 can receive one or more signals in response to performing the one or more actions. The response signals can indicate that one or more of the actions performed by the apparatus 140 have been observed. For instance, if a wake-up confirm signal is transmitted then any device that receives this signal can respond to indicate that the wake-up confirm signal has been received. If the actions that are performed by the apparatus 140 comprise other outputs such as emitting light or sounds then any devices that detect these could transmit signals to indicate that they have been detected.

The response signals could also provide additional information such as a location of nearby devices, a time stamp, an expected arrival time for a rescuer or other aid, or any other suitable information.

FIG. 2B shows an example method that could be implemented by a UE 110. The UE device 110 could be a device with a low power receiver and a main radio and/or could be any other suitable type of device. The UE 110 could be a smart phone or other communications device. The UE 110 could be configured for communication within a network 100 such as the network 100 of FIG. 1.

In the example method of FIG. 2B, at block 210, determining whether the UE 110 satisfies one or more location criteria.

In some examples the location criteria can be indicated in a broadcast signal that is received by the UE 110. The broadcast signal can be broadcast be a gNB or any other suitable network node 120.

The location criteria can be used to identify UEs 110 that are in the same geographical area as the apparatus 140 that is to be woken up. The geographical area can be determined based on a known or estimated location of the apparatus 140 that is is an intended recipient of the wake-up signal.

At block 212 the method comprises broadcasting a wake-up signal. The wake-up signals is broadcast based on the determination of whether the UE 110 satisfies the location criteria. That is, if the UE 110 satisfies the location criteria then the wake-up signal is broadcast. If the UE 110 does not satisfy the location criteria then the wake-up signal is no broadcast.

The wake-up signal comprises information identifying an apparatus or type of apparatus, and instructions to perform one or more actions in response to the wake-up signal.

The wake-up signal can be modulated so that the wake-up signal can be received by a low power receiver. In some examples the wake-up signal can be modulated so that it can be received by an on-off keying (OOK) receiver. The wake-up signal does not need to use OOK. For instance, Orthogonal Frequency Division Multiplexing (OFDM) or other types of modulation can be used to mimic OOK.

The method performed by the UE 110 can comprise blocks that are not shown in FIG. 2B. For instance, in some examples the UE 110 can receive a request to broadcast the wake-up signal. The wake-up signal can be broadcast in response to such requests. The request to broadcast the wake-up signal can be received in response to the UE 110 confirming that it satisfies the one or more location criteria. For instance, if at block 210 the UE determines that it satisfies the location criteria the UE 110 can transmit an indication of this to a network node 120 such as a gNB. The network node 120 can then select appropriate UEs for broadcasting the wake-up signal and can send a request to the selected UEs 110.

The request to broadcast the wake-up signal can comprise information identifying an apparatus 140 or type of apparatus 140 for which the wake-up signal is intended, and instructions for the apparatus 140 to perform one or more actions. At least some of this information can then be used for the wake-up signal.

In some examples, if the apparatus 140 receives the wake-up signal and performs one or more actions as instructed, then the UE 110 might observe the one or more actions. In such cases the UE 110 could transmit a signal to the apparatus 140 indicating that the one or more actions have been observed. Such signals could also provide additional information such as a location of nearby devices, a time stamp, an expected arrival time for a rescuer or other aid, or any other suitable information.

In some examples the wake-up signal can be broadcast automatically without any input from a user of the UE 110. In such cases if the UE 110 satisfies the location criteria then the UE 110 can transmit the wake-up signal without any input for a user 110. In other examples the wake-up signals could be broadcast in response to a user input. In such cases the UE 110 can comprise means for detecting a user input and enabling the wake-up signal to be broadcast in response to the detected user input. The means for detecting a user input could comprise any suitable type of user interface. This can enable the user to control if and when the wake-up signal is broadcast.

In the example of FIG. 2B the UE 110 can be configured to broadcast the wake-up signal directly to the apparatus 140. In other examples one or more intervening UEs 110 could be used to relay the wake-up signal to the apparatus 140.

For instance, the wake-up signal that is transmitted by the UE 110 could be detected by another UE 110. The UE 110 can then use the information identifying an apparatus or type of apparatus to determine if the wake-up signal is intended for the UE 110. In this case the UE 110 is not the apparatus 140 that the wake-up signal is intended for. Therefore, instead of performing the one or more actions as indicated in the wake-up signal the UE 110 can broadcast the wake-up signal. This can enable UEs 110 that satisfy the location criteria but which have not received a request to broadcast the wake-up signal from the network node 120 to broadcast the wake-up signal. For instance, this can enable UEs 110 that are outside of a cell coverage to broadcast the wake-up signal.

FIG. 2C shows an example method that could be implemented by a network node 120. The network node 120 could be a base station such as a gNB, a satellite such as a non-terrestrial network (NTN) satellite, or any other suitable type of device.

At block 220 the method comprises broadcasting a signal indicating one or more location criteria. The location criteria can be used to identify UEs 110 that are in the same geographical area as the apparatus 140 that is to be woken up. The geographical area can be determined based on a known or estimated location of the apparatus 140 that is an intended recipient of the wake-up signal.

At block 222 the method comprises using received responses to the broadcast signal to select to one or more UEs 110 for broadcasting a wake-up signal. The one or more UEs 110 can be selected based on location criteria and/or any other suitable criteria. For instance, the UEs 110 can be selected if they are located within an area defined by the network node 120.

If the network node 120 does not get a response from enough UEs 110 that satisfy the location criteria then the network node 120 could redefine the location criteria. For instance, the size of the area defined by the location criteria could be increased until a sufficient number of UEs 110 have been selected.

At block 224 the method comprises transmitting a request to broadcast the wake-up signal wherein the request is transmitted to the one or more selected UEs 110.

The request to broadcast a wake-up signal can comprise information to be used in the wake-up signal and any other suitable information. The information to be used in the wake-up signal can comprise the information identifying an apparatus or type of apparatus and instructions to perform one or more actions in response to the wake-up signal.

In the example of FIG. 2C the network node 120 enables a wake-up signal to be broadcast to an apparatus 140 via one or more intervening devices such as UEs 110.

In some examples the network node 120 could broadcast the wake-up signal itself. In such cases the wake-up signal comprises information identifying an apparatus or type of apparatus and instructions to perform one or more actions in response to the wake-up signal. The wake-up signal can be modulated so that the wake-up signal can be received by an on-off keying receiver. The wake-up signal can be broadcast using fixed radio resources. The wake-up signal can be repeated over a full discontinuous reception period.

FIG. 3 shows an example method that can be used in some use case scenarios. In this case the apparatus 140 is within coverage of a wake-up signal (WUS) transmitted by a gNB 120.

The apparatus 140 can be any suitable device or apparatus that is arranged in a low power state, as an implementation example of block 200 in FIG. 2A.

In some examples the low power state can be a state in which a low power receiver is turned on and able to receive WUS signals. In some examples when the apparatus 140 is in a low power state a main radio, or higher power receiver, is turned off. When the main radio is turned off the main radio is not able to receive signals from the gNB 120 or other wireless devices.

In some examples the apparatus 140 might only comprise the low power receiver and might not comprise any other receivers or radios.

In some examples the low power state can comprise a state in which other components of the apparatus 140 are in a low power mode. For example, output means such as lights, displays, or loudspeakers could be turned off or inactive. A processor or controller of the apparatus 140 could be in an idle state or a sleep mode when the apparatus 140 is in a low power state.

At block 300 the gNB 120 broadcasts the WUS. The WUS can be received by the apparatus 140 as an implementation example of block 202 in FIG. 2A.

In some examples the gNB 120 will broadcast the WUS if the gNB 120 satisfies location criteria. The location criteria could define an area and the gNB 120 can satisfy the location criteria if it is located within that area and/or if a WUS signal transmitted by the gNB 120 could be received within that area. For example, an expected location of one or more apparatus 140 could be determined and the area of the location criteria could be defined so as to comprise the expected location. The expected location could be estimated based on the last known location of the apparatus 140, a trajectory of the apparatus 140, or any other suitable information.

The WUS comprises information identifying the apparatus 140 or the type of apparatus 140. In some examples the WUS can comprise information uniquely identifying a specific apparatus 140. This could be used if the WUS is for is for a single entity. This could be used, for example, if a single person has gone missing and the WUS is to contact a device associated with the single person.

In some examples the WUS can comprise information identifying a type of apparatus. This could be used if there are multiple apparatus 140 that the gNB is to contact and/or if an identity of a single device is not known. This could be used, for example, if a group of people have gone missing but where multiple people in the group are associated with a type of device. For instance, if the people are wearing lifejackets equipped with an apparatus 140 or if they have other emergency equipment comprising an apparatus 140.

The WUS also comprises instructions for the apparatus 140 to perform one or more actions in response to receiving the WUS.

In some examples the WUS can comprise parameters as shown in table 1.

TABLE 1

| Parameter | Description |
|---|---|
| Apparatus ID | The apparatus ID can be hardcoded by the manufacturer |
| | of the apparatus. The apparatus ID is not assigned |
| | by the network 100 because the apparatus 140 might |
| | not have a main radio. |
| | If the apparatus ID is known, the WUS can be |
| | pinpointed to the specific apparatus otherwise |
| | the “apparatus type” parameter can be used. |
| Apparatus type | The WUS can address specific apparatus types as a |
| | group instead of waking single apparatus based on |
| | the apparatus ID. This is useful in cases where |
| | many apparatus of the same type are to be be woken |
| | up simultaneously for example, life vests, parachutes, |
| | skiing jackets or any other suitable apparatus 140. |
| | In case of an emergency event, the relevant type of |
| | apparatus can be woken up as a group. |
| Action | The action parameter can be used to select between |
| | different actions. The actions can enable aid or |
| | warnings to be provided to a user of the apparatus. |
| | Suitable actions can comprise turning on a light, start |
| | buzzing, start transmitting a simple long-range signal. |
| | Being able to select the action provides the benefit |
| | that the apparatus does not waste power or other |
| | resources on irrelevant actions such as starting a |
| | buzzer when it is stormy or switching on the |
| | light when it is daylight. |
| | A special kind of action can be to power on a main |
| | radio and report the position of the apparatus. This |
| | action requires that the apparatus has a main radio |
| | which can determine the position of the apparatus. |
| | If the action parameter is omitted, the apparatus |
| | can apply all its emergency actions. |
| | The action parameter could be a bitmask, where each |
| | bit maps to an emergency action. As an example: |
| | Bit 0: Switch on potential LED light if bit is enabled. |
| | Bit 1: Switch on potential buzzer if bit is enabled. |
| | Bit 2: Switch on potential transmitter if bit is enabled. |
| | Bit 3: Switch on potential main radio and report |
| | position if bit is enabled. |
| | Bit 4: Switch on potential main radio and broadcast |
| | position on sidelink interface (PC5) if bit is enabled. |

When the apparatus 140 receives the WUS the apparatus 140 can determine if the WUS is intended for the apparatus 140 as an implementation example of block 204 in FIG. 2A. The apparatus 140 can use the information identifying the apparatus 140 or the type of apparatus 140 comprised within the WUS to determine if the WUS is intended for the apparatus 140. The apparatus 140 can compare the information identifying the apparatus 140 or the type of apparatus comprised within the WUS to the identity or type of the apparatus 140.

If it is determined that the WUS is intended for the apparatus 140 then, at block 302 the apparatus 140 performs one or more of the actions indicated in the WUS, as an implementation example of block 206 in FIG. 2A. If it is determined that the WUS is not intended for the apparatus 140 then the apparatus 140 does not perform the one or more actions.

In some examples the apparatus 140 can be transitioned from the low power state to a high power state so as to enable the apparatus 140 to perform the one or more actions. This could enable an output such as a noise or light to be emitted by the apparatus 140 or could enable a response to the WUS to be transmitted by the apparatus 140 or could enable any other suitable type of action to be performed.

If it is determined that the WUS is not intended for the apparatus 140 then the apparatus 140 could remain in a low power state and would not transition to a high power state.

FIG. 4 shows another example method that can be used in some use case scenarios. In this case the apparatus 140 is not within coverage of a WUS transmitted by a gNB 120. In this case the WUS can be transmitted by a UE 110. The UE 110 could be a device that is carried by a rescue team or any other suitable type of device. The UE 110 could be carried into areas that are outside of network coverage such as caves or remote regions such as mountains.

The apparatus 140 can be any suitable device or apparatus that is arranged in a low power state, as an implementation example of block 200 in FIG. 2A. The apparatus 140 can be as described in relation to FIG. 3.

At block 400 the UE 110 broadcasts the WUS as an implementation example of block 212 in FIG. 2B. The apparatus 140 can receive the WUS as an implementation example of block 202 in FIG. 2A.

The UE 110 can broadcast the WUS in response to any suitable trigger event. In some examples the trigger event could comprise a determination that the UE 110 satisfies location criteria. The location criteria could define an area and the UE 110 can satisfy the location criteria if it is located within that defined area and/or if a WUS signal broadcast by the UE 110 could be received within that defined area. For example, an expected location of one or more apparatus 140 could be determined and the area of the location criteria could be defined so as to comprise the expected location. The expected location could be estimated based on the last known location of the apparatus 140, a trajectory of the apparatus 140, or any other suitable information.

In some examples the trigger event can comprise a user input. For instance, the UE 110 can be configured to detect a user input and transmit the WUS in response to the detected user input. The user input can be made using any suitable type of user interface such as touch screen, a key pad, buttons, voice activation, or any other suitable type of user inputs.

The WUS comprises information identifying the apparatus 140 or the type of apparatus. The information identifying the apparatus 140 or the type of apparatus can be as described above.

The WUS also comprises instructions for the apparatus 140 to perform one or more actions in response to receiving the WUS. When the apparatus 140 receives the WUS the apparatus 140 can determine if the WUS is intended for the apparatus 140. This can be an implementation example of block 204 in FIG. 2A and can be as described above.

The WUS can comprise parameters as shown in table 1 above and/or any other suitable parameters.

If it is determined that the WUS is intended for the apparatus 140 then, at block 402 the apparatus 140 performs one or more of the actions indicated in the WUS. If it is determined that the WUS is not intended for the apparatus 140 then the apparatus 140 does not perform the one or more actions.

FIG. 5 shows another example method that can be used in some use case scenarios. In this case the apparatus 140 is outside of the network coverage but the gNB 120 can instruct one or more UEs 110 to broadcast a WUS. The apparatus 140 can be in a low power state as an implementation example of block 200 in FIG. 2A.

At block 500 the gNB 120 broadcasts a signal to one or more UEs 110, as an implementation example of block 220 in FIG. 2C. Only one UE 110 is shown in the example of FIG. 5 but any number of UEs 110 could receive the broadcast signal in other examples.

The broadcast signal can be used to find candidate UEs 110 that can be used to broadcast a WUS. This can enable the UEs 110 to be used to relay the WUS to the apparatus 140.

Any suitable type of signal can be used as the broadcast signal. In some examples the signal can be a System information Broadcast (SIB) signal. The signal can be an SIBx signal. The SIBx signal can comprise parameters as shown in Table 2 and/or any other suitable parameters. The reference x can indicate a new SIB message or the parameters could be added to a new SIB message.

TABLE 2

| Parameter | Description |
|---|---|
| Geographical | To avoid too many responses to this broadcast, only |
| area | candidate UE's 110 inside the geographical area shall |
| | respond to the broadcast. If no response are received |
| | network node 120 can repeat the broadcast with a wider |
| | geographical until it gets a response on the broadcast. |

The geographical area that is defined in the broadcast signal can be determined by the know location of the apparatus 140 or an expected location of the apparatus 140.

At block 502 the gNB 120 can select one or more UEs 110 for broadcasting a WUS as an implementation example of block 222 of FIG. 2C. The gNB 120 can select the UEs 110 for transmitting the WUS based on received responses to the signal broadcast at block 500. For instance, if a UE 110 receives the broadcast signal then the UE 110 can transmit a response to the broadcast signal. In some examples the response could be establishing a Radio Resource Control (RRC) connection. The location of the UE 110 could be reported during the set up of the RRC connection. The gNB 120 can select UEs 110 for broadcasting a WUS based on the location of the UEs 110 and/or on any other suitable criteria.

At block 504 the gNB 120 transmits a request to broadcast a WUS to the selected UEs 110 as an implementation example of block 224 of FIG. 2C. Although one UE 110 is shown in FIG. 5 any number of UEs 110 could be selected in other examples.

The request to broadcast a WUS could be an RRC signal or any other suitable type of signal. In some examples the request to broadcast a WUS could be an RRCEmergent Wake-upReq. The RRCEmergentWake-upReq can comprise parameters as shown in Table 3 and/or any other suitable parameters.

TABLE 3

| Parameter | Description |
|---|---|
| Location | This parameter is used to identify the area in which the |
| Criteria | apparatus 140 is expected, and it is used to narrow down the |
| | gNB's 120/satellites/UEs 110 which shall broadcast WUS |
| Relaying | When this parameter is set to true, then the receiving UE 110 |
| | may relay the RRCEmergencyWake-upReq on the PC5 |
| | (sidelink) interface. |

The relaying parameter can enable the request to broadcast a WUS to be forwarded from the UE 110 to one or more other UEs 110. For instance, if the request to broadcast the WUS is received by a UE 110 that does not satisfy the location criteria then the request to broadcast the WUS can be forwarded to one or more other UEs 110. The request can be forwarded using a PC5 (sidelink) interface or any other suitable means.

The request to broadcast a WUS can also comprise information indicating actions that the apparatus 140 is to perform when it receives the WUS. This information can then be forwarded by the UE 110 in the WUS.

At block 506 the UE 110 determines if it is in the indicated geographic area for broadcasting the WUS, as an implementation example of block 210 of FIG. 2B. For example, the UE 110 can determine if it satisfies location criteria.

If the UE 110 is in the indicated geographic area then the UE 110 will broadcast the WUS at block 508, as an implementation example of block 212 of FIG. 2B. If the UE 110 is not in the indicated geographic area then the UE 110 does not broadcast or otherwise transmit the WUS.

The WUS that is broadcast at block 508 can be as described above. When the apparatus 140 receives the WUS the apparatus 140 can, at block 510, start to perform one or more actions as indicated in the WUS, as an implementation example of blocks 202 to 206 of FIG. 2A.

FIG. 6 shows another example method that can be used in some use case scenarios. In this case the apparatus 140 is outside of network coverage but the gNB can instruct one or more NTN satellites to broadcast the WUS. In this example the apparatus 140 can receive the WUS directly from the NTN satellite.

At block 600 the gNB 120 transmits a request to broadcast a WUS to an NTN satellite. Although one NTN satellite is shown in FIG. 6 any number of NTN satellites could be selected in other examples.

The request to broadcast a WUS could be an RRC signal or any other suitable type of signal. In some examples the request to broadcast a WUS could be an RRCEmergentWake-upReq. The RRCEmergentWake-upReq can comprise parameters as shown above in Table 3 above and/or any other suitable parameters.

The request to broadcast a WUS can also comprise information indicating actions that the apparatus 140 is to perform when it receives the WUS. This information can then be forwarded by the NTN satellite in the WUS.

The request to broadcast a WUS can also comprise information indicating the geographic area in which the WUS is to be broadcast. This area could be based on an expected location of the apparatus 140.

At block 602 the NTN can determine the geographic area for the WUS. The NTN can determine if it can cover the indicated geographic area for broadcasting the WUS. For example, the NTN can determine the beams to be used to cover the geographic area indicated in the request.

If the NTN can cover the indicated geographic area for broadcasting the WUS then, at block 604, the NTN satellite broadcasts the WUS using the appropriate beams.

The WUS that is broadcast at block 604 can be as described above. When the apparatus 140 receives the WUS the apparatus 140 can, at block 606, start to perform one or more actions as indicated in the WUS, as an implementation example of blocks 202 to 206 of FIG. 2A.

When an NTN satellite is used to broadcast signals there can be a severe doppler shift. The shift can be over 20 kHz for a low earth orbit satellite. To address this the NTN satellite can pre-compensate the broadcast WUS for the geographic region. In some examples the modulation used for the WUS can be selected to be resilient to large doppler shifts.

FIG. 7 shows another example method that can be used in some use case scenarios. This use case is similar to the use case of FIG. 6 in that the apparatus 140 is outside of network coverage and the gNB can instruct one or more NTN satellites to broadcast the WUS. However, in this case the NTN satellites can send the WUS via one or more UEs 110.

At block 700 the gNB 120 transmits a request to broadcast a WUS to an NTN satellite. Although one NTN satellite is shown in FIG. 7 any number of NTN satellites could be selected in other examples.

The request to broadcast a WUS could be an RRC signal or any other suitable type of signal. In some examples the request to broadcast a WUS could be an RRCEmergent Wake-upReq. The RRCEmergentWake-upReq can comprise parameters as shown above in Table 3 above and/or any other suitable parameters.

The request to broadcast a WUS can also include a parameter indicating that the WUS can be relayed from the NTN satellite to the apparatus 140 by one or more UEs.

At block 702 the NTN satellite broadcasts a signal to one or more UEs 110, as an implementation example of block 220 in FIG. 2C. Only one UE 110 is shown in the example of FIG. 7 but any number of UEs 110 could receive the broadcast signal in other examples.

The broadcast signal can be used to find candidate UEs 110 that can be used to broadcast a WUS. This can enable the UEs 110 to be used to relay the WUS from the NTN satellite to the apparatus 140.

Any suitable type of signal can be used as the broadcast signal. In some examples the signal can be a System information Broadcast (SIB) signal. The signal can be an SIBx signal. The SIBx signal can comprise parameters as shown above in Table 2 and/or any other suitable parameters.

The geographical area that is defined in the broadcast signal can be determined by the expected location of the apparatus 140 or by any other relevant factors.

At block 704 the NTN satellite can select one or more UEs 110 for broadcasting a WUS as an implementation example of block 222 of FIG. 2C. The NTN satellite can select the UEs 110 for broadcasting the WUS based on received responses to the signal broadcast at block 702. For instance, if a UE 110 receives the broadcast signal then the UE 110 can transmit a response to the broadcast signal. In some examples the response could be establishing a radio Resource Control (RRC) connection. The location of the UE 110 could be reported during the set up of the RRC connection. The NTN satellite can select UEs 110 for broadcasting a WUS based on the location of the UEs 110 and/or on any other suitable criteria.

At block 706 the NTN satellite transmits a request to broadcast a WUS to the selected UEs 110 as an implementation example of block 224 of FIG. 2C. Although one UE 110 is shown in FIG. 7 any number of UEs 110 could be selected in other examples.

The request to broadcast a WUS could be an RRC signal or any other suitable type of signal. In some examples the request to broadcast a WUS could be an RRCEmergent Wake-upReq. The RRCEmergent Wake-upReq can comprise parameters as shown above in Table 3 and/or can comprise any other suitable parameters.

The request to broadcast a WUS can also comprise information indicating actions that the apparatus 140 is to perform when it receives the WUS. This information can then be forwarded by the UE 110 in the WUS.

At block 708 the UE 110 determines if it is in the indicated geographic area for broadcasting the WUS as an implementation example of block 210 in FIG. 2B. For example, the UE 110 can determine if it satisfies location criteria.

If the UE 110 is in the indicated geographic area then the UE 110 will broadcast the WUS at block 710 as an implementation example of block 212 of FIG. 2B. If the UE 110 is not in the indicated geographic area then the UE 110 does not broadcast or otherwise transmit the WUS.

The WUS that is broadcast at block 710 can be as described above. When the apparatus 140 receives the WUS the apparatus 140 can determine if the WUS was intended for the apparatus 140 and, at block 712, start to perform one or more actions as indicated in the WUS as an implementation example of blocks 202 to 206 of FIG. 2A

The examples of FIGS. 3 to 7 show various examples in which a WUS can be broadcast to an apparatus 140 even if the apparatus 140 is out of network coverage. This can be used to trigger emergency or recovery actions at the apparatus 140 or to provide warnings. For example, it could be used to find people or other things that have gone missing. This can be achieved through the use of a low power and low cost receiver that could be integrated into different types of devices. The different types of devices could be electronic devices that could have a main radio that can be turned off for power saving and/or could be devices that do not have a main radio.

Examples of the disclosure could also be used for other use cases. For instance, they could be used to activate sensing devices where the sensing devices are out of network coverage and/or for any other suitable purpose.

The actions that can be performed by the apparatus 140 can be determined by the instructions in the WUS. In examples of the disclosure where the apparatus 140 is used for rescue or providing an emergency assistance the apparatus 140 could be configured to provide a beacon that can be used to help to find the apparatus 140. The beacon could be a light, a sound signal an RF signal or any other suitable type of signal.

In some examples the action could be to transmit a response to the WUS. The response could be transmitted by a main radio that is transitioned from an off state (or sleep state) to an on state in response to receiving the WUS. The response that is transmitted could include information relating to the location of the apparatus 140. In some examples the response that is transmitted could comprise an indication of the actions that have been performed in response to receiving the WUS. In some examples the response signal could comprise PC5EmergencyWake-upCnf signal or any other suitable type of signal. The PC5EmergencyWake-upCnf signal could comprise parameters as indicated in Table 4 and/or could comprise any other suitable parameters.

TABLE 4

| Parameter | Description |
|---|---|
| Position | Optional parameter (if positioning is supported) This |
| | parameter contains positioning information, such as |
| | longitude and latitude. |
| Emergency | This parameter shows which emergency actions that have |
| actions | been applied. This is useful information to know what to |
| | look for (For instance, light or sound). |

In examples where the apparatus 140 transmits a response signal the response can be detected by a UE 110 or by any other suitable device.

The UEs 110 or other device can transmit a signal indicating that one or more actions performed by the apparatus 140 has been observed. For instance, the UE 110 can detect the response signal or an audio signal or a light emitted by the apparatus 140 or any other suitable observable action. When the UE 110 or other device observes the action the UE 110 or other device can transmit a signal to the apparatus 140 indicating that the actions have been observed.

In some examples the response signal can comprise WUSEmergencyActionObservedRsp. The WUSEmergencyActionObservedRsp can comprise parameters as shown in Table 5 and/or any other suitable type of parameters.

TABLE 5

| Parameter | Description |
|---|---|
| Observed | This parameter contains information indicating the |
| emergency | emergency action that has been observed, for example |
| action | light or sound |
| Timestamp of | This parameter provides an indication of the timing of the |
| observation | emergency action |
| Estimate Time | Optional parameter indicating estimated time of arrival of |
| of Arrival | rescue team. |

FIGS. 8A and 8B show an example device 800 with a low power receiver 802 and a main radio 804. The device 800 could be an apparatus 140 as described above. In other examples the device 800 could be a UE 110 or any other suitable type of device. In the example of FIG. 8A the device 800 is arranged in a low power state and in the example of FIG. 8B the device 800 is arranged in a high power state.

The device 800 comprises a low power receiver 802 and a main radio 804. The device 800 could also comprise other components that are not shown in FIGS. 8A and 8B. For example, if the device 800 is an apparatus 140 it could comprise components that can enable one or more actions to be performed in response to a WUS. The components could comprise lights, loudspeakers or any other suitable components.

The low power receiver 802 is arranged so that it can be operated in an always on manner with very low power consumption. The power consumption of the low power receiver 802 can be very low compared to the power consumption of the main radio 804.

The low power receiver 802 can be arranged to receive the WUS. The low power receiver 802 can be arranged so that the only signals it can receive are WUS. This could be arranged through the design of the WUS and the hardware of the device 800. The low power receiver 802 does not receive signals such as NR signals that could be transmitted by wireless interfaces in networks 100 such as the network 100 shown in FIG. 1.

The main radio 804 can be arranged so that it can receive signals such as NR signals that could be transmitted by wireless interfaces in networks 100 such as the network 100 shown in FIG. 1.

In the low power state as shown in FIG. 8A the main radio 804 is arranged in an off mode for power saving. In some examples the main radio 804 could be in a sleep mode or a deep sleep mode. When the main radio 804 is in the off state or in a sleep mode the main radio 804 does not receive or transmit any network signals such as NR signals.

The low power receiver 802 is arranged to detect a WUS. While no WUS is received the device 800 will remain in the low power state.

The device 800 can transition from the low power state (as shown in FIG. 8A) to a high power state (as shown in FIG. 8B) in response to the receipt of a WUS by the low power receiver. The WUS can be an emergency WUS as described above.

In the high power state the main radio 804 is arranged in an on mode. When the main radio 804 is in the on state the main radio 804 can receive or transmit network signals such as NR signals.

Once the device 800 is arranged in the high power state the device 800 can perform other actions. For instance, if the device 800 is an apparatus 140 then the apparatus 140 can perform actions such as actions indicated in the WUS the actions could be transmitting a signal using the main radio 804 or performing other actions such as emitting a light or audio alert.

In examples of the disclosure the WUS signal can be modulated so that it can be received by an OOK receiver. In some examples the WUS can be modulated using OFDM so as to mimic OOK. For instance, a set of sub-carriers can be switch ON/OFF per OFDM symbol. This can be referred to as Multicarrier OOK (MC-OOK) because multiple carriers are switched on and off.

The low power receiver of the apparatus 140, or any other device 800 that can detect the WUS, can be arranged to detect the symbols by detecting the signal power after filtering the relevant subcarriers. Some guard subcarriers may be used. The number of guard subcarriers used will determine the order of the filter that is used. Manchester encoding, or other suitable encoding format, can be applied to the transmitted symbols. The encoding ensures a constant DC level of the transmitted WUS. The constant DC level enables the receiving device to compare the detected power with a threshold value where the threshold value is equal to the average power level.

OOK signals can be classed as OFDM symbol OOK or DFT (Direct Fourier Transform)-s-OFDM based OOK.

For OFDM symbol OOK the switching ON/OFF is at the symbol rate. The entire bandwidth (BW) is used to transmit a portion of the Manchester encoded bit. OFDM symbol OOK is robust against frequency selective fading but under uses the useful spectrum.

DFT-s-OFDM based OOK involves DFT spreading using M point DFT before the final M<<N point Inverse Fast Fourier Transform (IFFT). This allows multiple OOK symbols or multiple ON/OFF durations of an OOK symbol to be transmitted in an OFDM symbol depending on the BW of the WUS. Therefore, this uses the available spectrum efficiency because more bits can be transmitted in an OFDM symbol.

However, DFT-s-OFDM based OOK does increase complexity. The BW determines the smearing of ON/OFF signaling and the performance can be affected by Inter Symbol Interference (ISI) in a rich scattering environment. Some of these issues can be resolved by using sufficiently long ON/OFF durations.

FIG. 9 schematically shows an example of how an OOK signal can be approximated inside an OFDM symbol using DFT-s-OFDM based OOK. In this example the wanted OOK symbol 1000 is up-sampled to the wanted sampling rate. The up-sampling factor is given by M/K where M is the number of subcarriers allocated for the WUS and K is the number of OOK ON/OFF symbols per OFDM symbol.

The OOK symbol 900 is converted to the frequency domain by an M-point DFT 902. The M-point DFT 902 provides the Resource Elements (Res) 904 for the WUS as an output. The REs 1004 and non-OOK data 1006 are input to an IFFT 908. The IFFT provides a time domain signal 910 as an output.

FIG. 10 shows an example of an OOK signal inside an OFDM symbol. In this case the sequence “1, 0, 1, 0, 0, 1, 1, 0” is approximated inside an OFDM symbol.

The ideal OOK signal would be a square wave as indicated by plot 1000. The generated OOK signal is a best fit using an M-point DFT approach and is indicated by plot 1002.

The OOK signal can coexist with other NR signals inside the same OFDM symbol because the OOK signal is generated using normal NR subcarriers and SCS.

FIG. 11 schematically shows an example OOK receiver. The OOK receiver comprises a matching network 1100, a Radio Frequency (RF) Band Pass Filter (BPF) 1102, an RF Low Noise Amplifier (LNA) 1104, a mixer 1106 and local oscillator (LO) 1108, a Baseband (BB) amplifier 1110, a BB Low Pass Filter (LPF) 1112, and an analog to digital converter (ADC 1114).

The OOK receiver is arranged so that a received signal is passed through the matching network 1100 before it is provided to the RF BPF 1102. The filtered signal is amplified by the LNA 1104 and mixed with the signal from the LO 1108 before being down converted to a BB or Intermediate Frequency IF. The down converted signal is passed through the BB LPF 1112 to remove unwanted signal. In some examples a BPF can be used instead of the BB LPF 1112. The filtered signal is then provided to the ADC 1114 to generate a digital output that can be used for digital BB processing 1116.

The example receiver shown in FIG. 11 only uses a few hardware blocks, a low resolution ACD 1114 with a low clock, and it does not use advanced baseband processing. The receiver is therefore a very power efficient receiver.

FIG. 12 schematically shows another example OOK receiver. The OOK receiver of FIG. 12 can be used if Frequency Shift keying (FSK) has been used for modulation of the WUS.

The OOK of FIG. 12 comprises a matching network 1100, a Radio Frequency (RF) Band Pass Filter (BPF) 1102, an RF Low Noise Amplifier (LNA) 1104, a mixer 1106 and local oscillator (LO) 1108, a Baseband (BB) amplifier 1110. These can be as shown in FIG. 11 and described above.

The OOK receiver also comprises two branches where each branch comprises a BB BPF 1112 and ADC 1114. The BB BPF 1112A in the first branch filters for a first frequency f₀ and the BB BPF 1112B in the first branch filters for a second frequency f₁. The respective filtered signals are then provided to the ADC 1114 to generate a digital output that can be used for digital BB processing 1116.

FIG. 13 illustrates an example controller 1300. The controller 1300 could be provided within any suitable devices such as an apparatus 140, a UE 110 or a network node 120. Implementation of the controller 1300 may be as controller circuitry. The controller 1300 may be implemented in hardware alone, have certain aspects in software including firmware alone or can be a combination of hardware and software (including firmware).

As illustrated in FIG. 13 the controller 1300 can be implemented using instructions that enable hardware functionality, for example, by using executable instructions of a computer program 1306 in a general-purpose or special-purpose processor 1302 that may be stored on a computer readable storage medium (disk, memory etc.) to be executed by such a processor 1302.

The processor 1302 is configured to read from and write to the memory 1304. The processor 1302 may also comprise an output interface via which data and/or commands are output by the processor 1302 and an input interface via which data and/or commands are input to the processor 1302.

The memory 1304 stores a computer program 1306 comprising computer program instructions (computer program code) that controls the operation of the controller 1300 when loaded into the processor 1302. The computer program instructions, of the computer program 1306, provide the logic and routines that enables the apparatus to perform the methods illustrated in the Figs. The processor 1302 by reading the memory 1304 is able to load and execute the computer program 1306.

The controller 1300 therefore comprises: at least one processor 1302; and at least one memory 1304 storing instructions that, when executed by the at least one processor 1302, cause an apparatus 140 at least to perform:
arranging 200 the apparatus 140 in a low power state;
receiving 202 a wake-up signal wherein the wake-up signal is received using a low power receiver that is operable in the low power state and the wake-up signal comprises information identifying an apparatus or type of apparatus, and instructions to perform one or more actions in response to the wake-up signal;
determining 204 if the wake-up signal is intended for the apparatus 140 based on the information identifying an apparatus or type of apparatus in the wake-up signal; and
performing 206 the one or more actions indicated in the wake-up signal based on the determination.

The controller 1300 therefore comprises: at least one processor 1302; and at least one memory 1304 storing instructions that, when executed by the at least one processor 1302, cause a UE 110 at least to perform:
determining 210 whether the UE 110 satisfies one or more location criteria; and
broadcasting 212 a wake-up signal based on the determination wherein the wake-up signal comprises information identifying an apparatus or type of apparatus, and instructions to perform one or more actions in response to the wake-up signal.

The controller 1300 therefore comprises: at least one processor 1302; and at least one memory 1304 storing instructions that, when executed by the at least one processor 1302, cause a network node 120 at least to perform:
broadcasting 220 a signal indicating one or more location criteria;
using received responses to the broadcast signal to select 222 to one or more UEs 110 for broadcasting a wake-up signal; and
transmitting 224 a request to broadcast the wake-up signal wherein the request is transmitted to the one or more selected UE 110.

The computer program 1306 may arrive at the UE 110 or gNB 120 via any suitable delivery mechanism 1308. The delivery mechanism 1308 may be, for example, a machine-readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1306. The delivery mechanism may be a signal configured to reliably transfer the computer program 1306. The apparatus may propagate or transmit the computer program 1306 as a computer data signal.

The computer program 1306 can comprise computer program instructions for causing an apparatus 140 to perform at least the following or for performing at least the following:
arranging 200 the apparatus 140 in a low power state;
receiving 202 a wake-up signal wherein the wake-up signal is received using a low power receiver that is operable in the low power state and the wake-up signal comprises information identifying an apparatus or type of apparatus, and instructions to perform one or more actions in response to the wake-up signal;
determining 204 if the wake-up signal is intended for the apparatus 140 based on the information identifying an apparatus or type of apparatus in the wake-up signal; and
performing 206 the one or more actions indicated in the wake-up signal based on the determination.

The computer program 1306 can comprise computer program instructions for causing a UE 110 to perform at least the following or for performing at least the following:
determining 210 whether the UE 110 satisfies one or more location criteria; and
broadcasting 212 a wake-up signal based on the determination wherein the wake-up signal comprises information identifying an apparatus or type of apparatus, and instructions to perform one or more actions in response to the wake-up signal.

The computer program 1306 can comprise computer program instructions for causing a network node 120 to perform at least the following or for performing at least the following:
broadcasting 220 a signal indicating one or more location criteria;
using received responses to the broadcast signal to select 222 to one or more UEs 110 for broadcasting a wake-up signal; and
transmitting 224 a request to broadcast the wake-up signal wherein the request is transmitted to the one or more selected UE 110.

The computer program instructions may be comprised in a computer program, a non-transitory computer readable medium, a computer program product, a machine-readable medium. In some but not necessarily all examples, the computer program instructions may be distributed over more than one computer program.

Although the memory 1304 is illustrated as a single component/circuitry it may be implemented as one or more separate components/circuitry some or all of which may be integrated/removable and/or may provide permanent/semi-permanent/dynamic/cached storage.

Although the processor 1302 is illustrated as a single component/circuitry it may be implemented as one or more separate components/circuitry some or all of which may be integrated/removable. The processor 1302 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The stages illustrated in the Figs. can represent steps in a method and/or sections of code in the computer program 1306. The illustration of a particular order to the blocks does not necessarily imply that there is a required or preferred order for the blocks and the order and arrangement of the block may be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus comprising:
at least one processor, and
at least one memory storing computer program codes that,
when executed by the at least one processor, cause the apparatus at least to:
arrange the apparatus in a low power state;
receive a wake-up signal with a low power receiver that is operable in the low power state and the wake-up signal comprises information identifying an apparatus or type of apparatus, and instructions to perform one or more actions in response to the wake-up signal;
determine if the wake-up signal is intended for the apparatus based on the information identifying an apparatus or type of apparatus in the wake-up signal; and
perform the one or more actions indicated in the wake-up signal based on the determination.

2. The apparatus as claimed in claim 1,
wherein the computer program codes, when executed by the at least one processor, further cause the apparatus to transition the apparatus to a high power state to perform the one or more actions.

3. The apparatus as claimed claim 1, wherein the apparatus comprises a main radio wherein the main radio is separate from the low power receiver, has a higher power usage than the low power receiver and is arranged in an off state when the apparatus is in the low power state.

4. The apparatus as claimed in claim 1, wherein the wake-up signal is modulated so that the wake-up signal can be received by an on-off keying receiver.

5. The apparatus as claimed in claim 1, wherein the one or more actions comprise transmitting a wake-up confirm signal.

6. The apparatus as claimed in claim 5 wherein the wake-up confirm signal comprises at least one of:
location information of the apparatus;
an indication of one or more actions that have been initiated by the apparatus.

7. The apparatus as claimed in claim 5 wherein the wake-up confirm signal is modulated using on-off keying.

8. The apparatus as claimed in claim 1,
wherein the computer program codes, when executed by the at least one processor, further cause the apparatus to receive a signal in response to the one or more actions wherein the signal indicates that one or more of the actions performed by the apparatus have been observed.

9. An apparatus as claimed in claim 1, wherein the apparatus is at least one of, an emergency device, a sensing device, a localisation device, an Internet of Things device.

10. A user equipment comprising:
at least one processor, and
at least one memory storing computer program codes that,
when executed by the at least one processor, cause the user equipment at least to:
determine whether the user equipment satisfies one or more location criteria; and
broadcast a wake-up signal based on the determination wherein the wake-up signal comprises information identifying an apparatus or type of apparatus, and instructions to perform one or more actions in response to the wake-up signal.

11. The user equipment as claimed in claim 10 wherein the wake-up signal is modulated so that the wake-up signal can be received by an on-off keying receiver.

12. The user equipment as claimed in claim 10, wherein the computer program codes, when executed by the at least one processor, further cause the user equipment to receive a broadcast signal wherein the broadcast signal indicates the one or more location criteria.

13. The user equipment as claimed in claim 10, wherein the computer program codes, when executed by the at least one processor, further cause the user equipment to receive a request to broadcast the wake-up signal.

14. The user equipment as claimed in claim 13, wherein the information identifying an apparatus or type of apparatus, and instructions to perform one or more actions used in the wake-up signal are based on information received in the request to broadcast the wake-up signal.

15. The user equipment as claimed in claim 10, wherein the computer program codes, when executed by the at least one processor, further cause the user equipment to transmit an indication that one or more actions performed by an apparatus have been observed.

16. The user equipment as claimed in claim 10, wherein the computer program codes, when executed by the at least one processor, further cause the user equipment to detect a user input and broadcasting the wake-up signal in response to the detected user input.

17. A network node comprising:
at least one processor, and
at least one memory storing computer program codes that,
when executed by the at least one processor, cause the network node at least to:
broadcast a signal indicating one or more location criteria;
use received responses to the broadcast signal to select to one or more user equipments for broadcasting a wake-up signal; and
transmit a request to broadcast the wake-up signal wherein the request is transmitted to the one or more selected user equipment.

18. The network node as claimed in claim 17 wherein the one or more user equipments are selected based on location criteria.

19. The network node as claimed in claim 17, wherein the request to broadcast a wake-up signal comprises information to be used in the wake-up signal.

20. The network node as claimed in claim 17, wherein the network node is one of:
a base station,
a satellite.
